(19) United States
(12) Patent Application Publication
(10) Pub. No.: US 2006/0170768 A1
(43) Pub. Date: Aug. 3, 2006

(54) Mobile under vehicle inspection system

(76) Inventor: Larry E. Riley, Fritz Creek, AK (US)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 11/045,074

(22) Filed: Jan. 31, 2005

(51) Int. Cl. H04N 7/18; H04N 9/47

(52) U.S. Cl. 348/143

(57) ABSTRACT

An under vehicle inspection system is disclosed. The under vehicle inspection system comprises a vehicle undercarriage inspection platform, a plurality of sensors mounted on the vehicle undercarriage inspection platform, and a data analysis element receiving and evaluating data captured by the plurality of sensors. The plurality of sensors scans the undercarriage of a vehicle by moving relative to the vehicle undercarriage inspection platform.

### STATEMENT OF GOVERNMENT SPONSORED RESEARCH

One or more agencies of the United States Government have a paid-up license in this invention and may in limited circumstances possess the right to require the patent owner to license others on reasonable terms as provided by the terms of Government Contract Number N00164-04-C-6653 awarded by the Naval Surface Warfare Center, Crane, Ind.

### BACKGROUND OF THE INVENTION

1. Field of the Invention

The invention relates generally to an under vehicle inspection system. More particularly, the invention relates to a mobile under vehicle inspection system adapted for use in potentially dangerous or high traffic environments.

2. Description of the Related Art

Criminals and terrorists have been known to transport drugs, explosives, stolen goods, and other forms of contraband in the undercarriages of vehicles. The term “undercarriage” here refers to all or part of the underside of a vehicle, including various nooks and crannies such as the wheel wells and areas between engine parts. Inspection stations have traditionally been set up in a variety of locations to prevent the passage of forbidden or unwanted items hidden in the undercarriages of vehicles. For example, international and state border crossings, airports, military and security checkpoints, and even many commercial structures are protected by systems designed to inspect vehicle undercarriages.

Perhaps the most common method used to perform under vehicle inspections involves a human inspector manipulating a mirror attached to the end of a stick. The inspector manually positions the mirror underneath a vehicle in such a way that he or she can view portions of the vehicle's underside in the mirror's reflection. This allows the inspector to examine the vehicle's underside without having to kneel down or crawl underneath the vehicle.

The so called “mirror on a stick” approach has a number of fairly obvious shortcomings. Most notably, this approach puts the inspector in physical danger by placing him or her near potentially harmful substances, e.g. explosives, caustic chemicals, biological weapons, etc. Furthermore, scanning the entire underside of a vehicle using a mirror on a stick takes a considerable amount of time, which typically leads to serious congestion in high traffic areas. Moreover, human inspectors often fail to notice important details when they are fatigued or in a rush, thereby limiting the reliability of their inspections.

A number of more sophisticated approaches have been proposed in an attempted to provide safer, more efficient, and more reliable ways of inspecting vehicle undercarriages. The most common alternative approaches include stationary under vehicle scanners and unmanned ground vehicles.

A stationary under vehicle scanner is a fixed unit that collects data from the underside of a vehicle as the vehicle passes over it. Typically, a stationary under vehicle scanner comprises a camera strip that captures a number of images of the vehicle's underside and then sends the images to a human inspector for analysis. An example of a stationary under vehicle scanner is disclosed in U.S. Patent Application Publication No. 2003/0185340.

An unmanned ground vehicle (UGV) is a mobile robot that collects data from the underside of a vehicle by moving around underneath the vehicle. Typically, an UGV comprises a semi-autonomous unit with a camera and a transmitter mounted on top of it. The UGV takes pictures of the vehicle's underside as it moves around and sends the images to a human inspector for analysis.

Stationary under vehicle scanners and UGVs each have some major problems. Stationary under vehicle scanners, for instance, often produce blurry images due to the fact that vehicles often travel at inconsistent speeds and experience some form of mechanical vibration as they pass over the scanning point. Furthermore, cameras fixed in stationary under vehicle scanners are generally incapable of selectively focusing in on suspicious areas of the undercarriage or adjusting their imaging view around a difficult angle. As such, stationary under vehicle scanners are unable to inspect areas such as wheel wells, which are a common place for stowing illegal items.

UGVs, on the other hand, experience poor and inconsistent image quality due to frequent image transmission failures caused by the mobile unit losing line of sight with a receiver station or due to radio frequency interference. In addition, because UGVs have a fixed size, they cannot adapt to the varying heights of vehicle undercarriages, and therefore cannot accommodate the international ground clearance standard of one (1) inch. Another problem with UGVs is that they have trouble moving around on poor or uneven surfaces such as mud or gravel. Furthermore, inspections made by UGVs are usually random, as the mobile robot moves around selected areas of the vehicle undercarriage rather than uniformly scanning the entire structure. Finally, as with stationary under vehicle scanners, UGVs are unable to inspect most wheel wells because their available view angles are often obstructed by vehicle wheels and other vehicle parts.

Due to these and other manifest limitations in the proposed approaches, the “mirror on a stick” method remains the most reliable form of under vehicle inspection. Given the great risk that this method presents to inspection personnel, however, the “mirror on a stick” approach is unacceptable.

What is needed, therefore, is a system which is at least as reliable as the “mirror on a stick” approach, yet which provides a safe and efficient way of inspecting the undercarriages of vehicles.

### SUMMARY OF THE INVENTION

The present invention provides an under vehicle inspection system capable of reliably and efficiently detecting suspicious articles in the undercarriages of vehicles while minimizing the risk of physical harm to inspection personnel. In one embodiment, the present invention allows suspicious areas in the undercarriages of vehicles to be selectively and more thoroughly inspected, and it allows obstructed areas of the vehicle undercarriage such as wheel wells to be effectively inspected.

According to one exemplary embodiment of the invention, an under vehicle inspection system comprises a vehicle undercarriage inspection platform and a plurality of sensors mounted on the vehicle undercarriage inspection platform. The plurality of sensors is adapted to scan all or part of the vehicle undercarriage by moving relative to the vehicle undercarriage inspection platform. The system further comprises a data analysis element receiving and evaluating data captured by the plurality of sensors.

According to another exemplary embodiment of the invention, a method of inspecting a vehicle undercarriage is provided. The method comprises scanning the vehicle undercarriage using a plurality of sensors mounted on a vehicle undercarriage inspection platform, and evaluating data captured by the plurality of sensors. Thus, in a related aspect, the step of scanning the vehicle undercarriage comprises moving the plurality of sensors relative to the vehicle undercarriage inspection platform.

According to still another embodiment of the invention, another method of inspecting a vehicle undercarriage is provided. The method comprises driving the vehicle onto a vehicle undercarriage inspection platform, maintaining the vehicle in a stationary position relative to the vehicle undercarriage inspection platform while a plurality of sensors mounted on the undercarriage inspection platform scans the vehicle undercarriage. In a related aspect, data captured by the plurality of sensors is communicated to a data analysis element and evaluated.

### BRIEF DESCRIPTION OF THE DRAWINGS

Embodiments of the invention are described in relation to the accompanying drawings. Throughout the drawings like reference numbers indicate like exemplary elements, components, or steps. In the drawings:

FIG. 1 is a conceptual diagram of an under vehicle inspection system in accordance with one exemplary embodiment;

FIG. 2 is a conceptual diagram of an under vehicle inspection system in accordance with another exemplary embodiment;

FIGS. 3A through 3D are different views of a vehicle undercarriage inspection platform in accordance with an exemplary embodiment;

FIG. 4 is a flow chart describing a method of inspecting the undercarriage of a vehicle in accordance with an exemplary embodiment;

FIG. 5 is a flow chart describing a method of inspecting the undercarriage of a vehicle in accordance with another exemplary embodiment.

### DESCRIPTION OF THE EXEMPLARY EMBODIMENTS

Exemplary embodiments of the invention are described below with reference to the corresponding drawings. These embodiments are presented as teaching examples. The actual scope of the invention is defined by the claims that follow.

One embodiment of the present invention provides an under vehicle inspection system, wherein the system comprises a vehicle undercarriage inspection platform and a plurality of sensors mounted on the vehicle undercarriage inspection platform. The plurality of sensors is adapted to scan all or part of the vehicle undercarriage by moving relative to the vehicle undercarriage inspection platform. Data captured by the plurality of sensors is communicated to an analysis element and evaluated.

The term “platform” is used throughout this description to denote any physical structure capable of receiving and supporting a vehicle, in whole or in part, in such a manner that a plurality of sensors associated with the platform may view some portion of the vehicle's undercarriage. For example, the vehicle undercarriage inspection platform may take the form of movable mechanical structure, such as a trailer or a collection of welded beams. It may also take the form of an in-ground or on-ground construction formed by a mechanical or concrete structure. The plurality of sensors need not be physically connected or mechanically attached to the platform, but several embodiments of the invention recognize certain benefits in an arrangement where the plurality of sensors is mechanically attached to the platform.

The term “sensor” is used throughout this description in its broadest sense. Thus, any device that receives stimuli (e.g. heat, pressure, light, motion, electromagnetic fields, or a chemical response, etc.) from its surrounding environment and responds to the stimuli in a distinctive way is considered a sensor for purposes of this description. The term “sensor” includes both passive sensors, i.e. those that do not interact with their environment, as well as active sensors, i.e. those that do. Ready examples of sensors adapted for use within the context of the invention include optical (both visible light and infrared) cameras, radiation sensors, thermal sensors, chemical detectors, and motion detectors, etc.

Where the sensors comprise optical cameras, the cameras are typically either still cameras or video cameras and they may be digital or film based. Where the cameras are digital cameras, they typically include charge coupled device (CCD) or complementary metal oxide semiconductor (CMOS) based image sensors.

According to one embodiment, at least one of the plurality of sensors is a digital line scan camera. The digital line scan camera typically uses a linear array of CCDs to build up a series of single pixel lines, thereby creating a final image. This allows the camera to create an image covering a large area of a vehicle's undercarriage without having to rely on techniques such as stitching together multiple images. In addition, the digital line scan camera provides exceptional resolution and zoom capability, thereby allowing the under vehicle inspection system to consider the fine details of a vehicle's undercarriage.

The plurality of sensors are typically capable of moving relative to the vehicle undercarriage inspection platform in at least one direction, including vertically, horizontally, angularly, rotationally, or any combination of thereof. Individual sensors within the plurality may be independently moved and/or moved as a coordinated plurality. Furthermore, individual or grouped sensors may perform their respective functions at varying ranges of resolution and/or sensitivity. For example, cameras may zoom in and zoom out, chemical detectors may be adjusted to detect varying levels of chemical concentration, and so forth.

The term “data analysis element” refers to any system capable of receiving and/or evaluating data derived from the plurality of sensors. Evaluating data typically comprises classifying the data as “suspicious” or “not suspicious.” One example of a data analysis element is a human operator viewing image data derived from the plurality of sensors on a display and evaluating the images using a set of objective and/or subjective criteria. Another example of a data analysis element is a digital logic system receiving digital data from the plurality of sensors and classifying the data using machine learning techniques, or a simple threshold based system, whereby a predetermined response (e.g. an alarm) is triggered anytime a certain parameter exceeds an allowable threshold.

The data analysis element typically receives data captured by at least one of the sensors through some form of intermediate link connecting the data analysis element with the plurality of sensors. This link may be formed using a hardwire connection or a wireless connection. Many embodiments of the invention will preferably use a hardwire connection, as wireless transmission will be deemed undesirable. Where the link is a hardwire connection, the hardwire connection may use any of a variety of protocols, components, and transmission media, including Ethernet, copper wire, fiber optic, and so forth. Where the link is a wireless connection, the wireless connection may use any one of a variety of protocols and components, including Bluetooth, 802.11, lasers, radio frequency communication, etc.

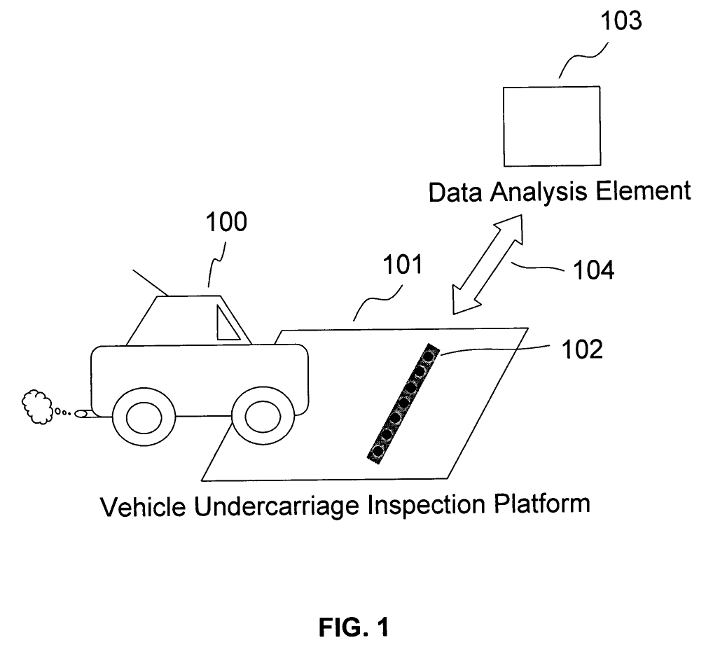

FIG. 1 is a conceptual diagram of an under vehicle inspection system in accordance with one embodiment of the invention. Referring to FIG. 1, an under vehicle inspection system comprises a vehicle undercarriage inspection platform 101, a plurality of sensors 102 mounted on vehicle undercarriage inspection platform 101, and a data analysis element 103 receiving data captured by the plurality of sensors 102 and evaluating the data. The plurality of sensors 102 scans the undercarriage of a vehicle 100 by moving relative to the vehicle undercarriage inspection platform. A link 104 transmits data captured by the plurality of sensors 102 to data analysis element 103.

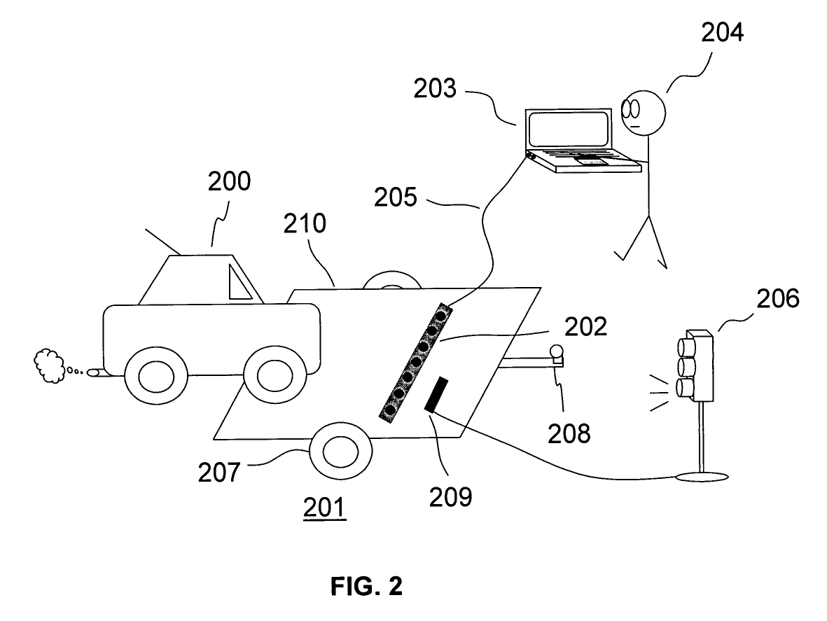

FIG. 2 is a conceptual drawing of an under vehicle inspection system in accordance with another embodiment of the invention. Referring to FIG. 2, an under vehicle inspection system comprises a vehicle undercarriage inspection platform in the form of a moveable trailer 201, a plurality of cameras 202 mounted on trailer 201, a computer 203 (e.g., a laptop or table Personal Computer (PC) or Personal Digital Assistant (PDA) receiving data captured by the plurality of cameras 202 and displaying the data as visual images on a display, a human operator 204 evaluating the visual images, and a hardwire connection 205 transmitting the data captured by the plurality of cameras 202 to computer 203.

The plurality of cameras 202 captures image data for the undercarriage of a vehicle 200 by moving across the length of trailer 201 at a consistent speed and scanning as it goes. Trailer 201 typically comprises a metal frame assembly 210 mounted on wheels 207 and attached to a trailer hitch 208 in a manner consistent with conventional trailers capable of being towed behind a vehicle.

The under vehicle inspection system optionally comprises an associated signaling system 206 that controls passage of vehicle 200 over trailer 201 and signals the vehicle's operator when the vehicle is properly positioned for scanning. Signaling system 206 typically turns on a red light/green light combination, but may take any number of other forms. Signaling system 206 may be associated with one or more detection devices adapted to indicate whether a vehicle is properly positioned on trailer 201. A pressure sensor 209 appropriately located on trailer 201 in one example of such a detection device. Alternatively, human operator 204 may visually determine whether vehicle 200 is properly positioned on trailer 201 for inspection.

Power is generally provided to the under vehicle inspection system by electrical mains and/or a portable gasoline/diesel generator. Alternative sources of power for the under vehicle inspection system include, for example, solar power, batteries, etc.

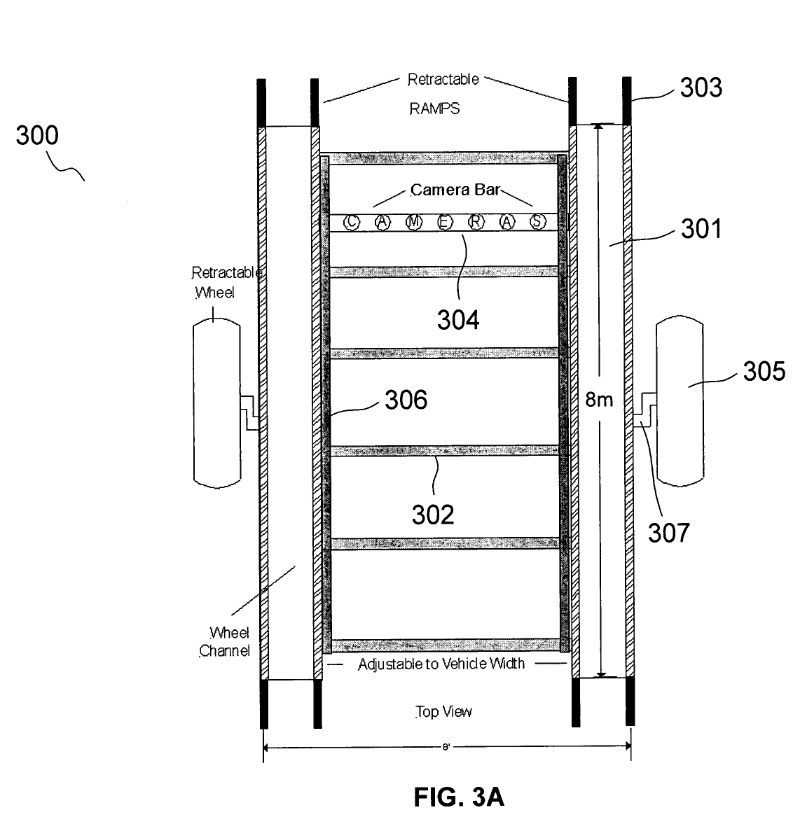

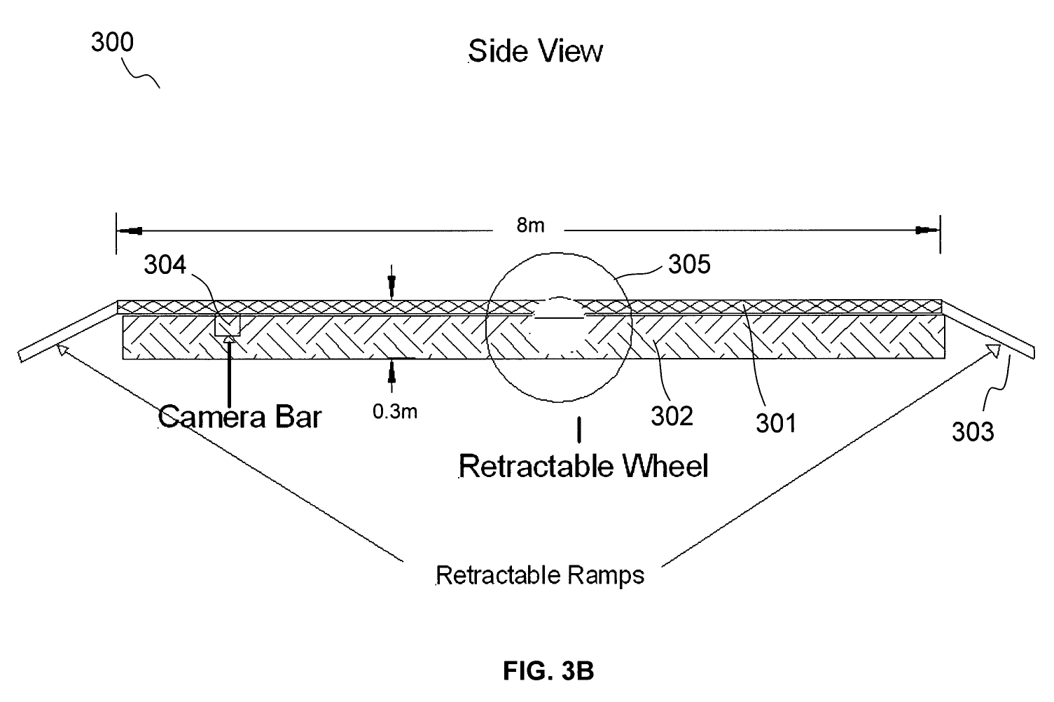

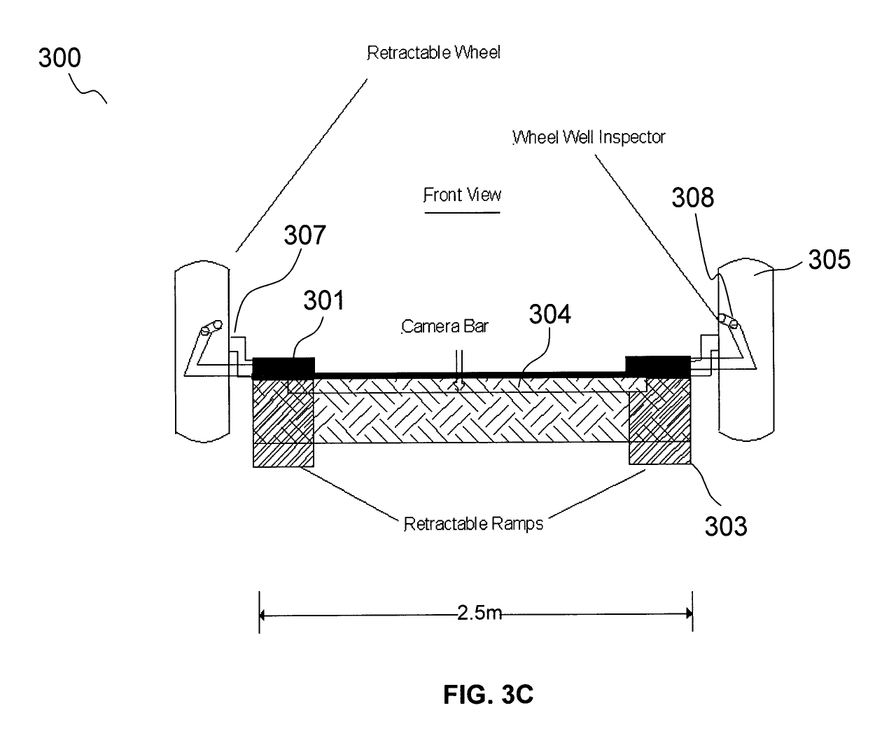

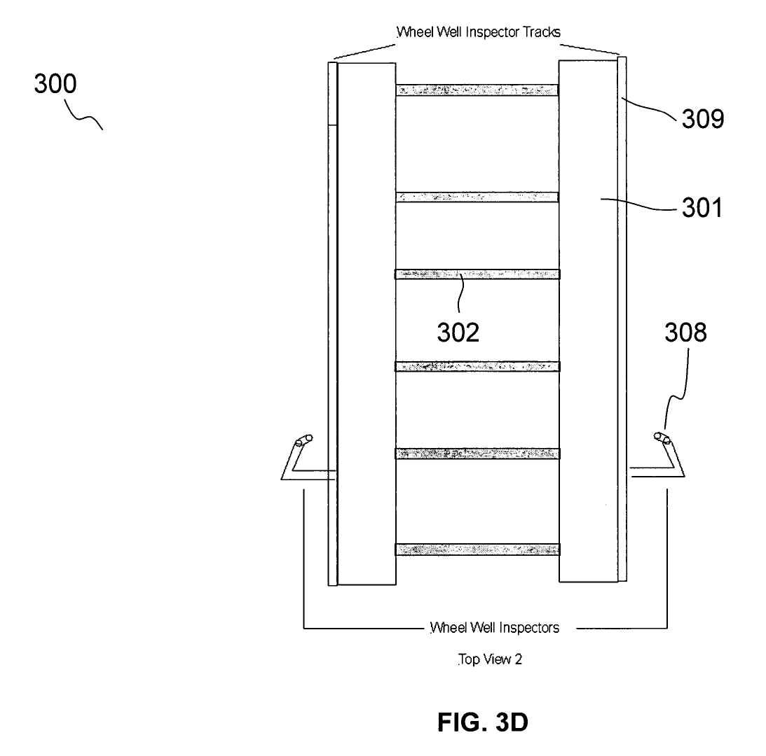

FIG. 3A is a first top view of a trailer 300 adapted for use in an embodiment of the invention like the one shown in FIG. 2. Referring to FIG. 3A, trailer 300 comprises wheel channels 301 connected to a frame 302, retractable ramps 303 attached to both ends of wheel channels 301, retractable wheels 305 attached to frame 302, and a camera bar 304 having a plurality of cameras mounted thereon. Camera bar 304 moves down the length of trailer 300 on a camera bar track 306 attached to frame 302. The length of wheel channels 301 is generally about 8 m, although this length can vary.

Camera bar 304 generally captures images of the undercarriage of a vehicle by scanning down the length of trailer 300 at a predetermined speed. In many cases, the speed at which camera bar 304 moves may be variably adjusted according to the vehicle being scanned or according to the region of the vehicle being scanned. The camera mounted on camera bar 304 may provide zoom capability so that suspicious areas of the vehicle undercarriage may be examined more thoroughly. Furthermore, where necessary, camera bar 304 may make multiple passes over a selected area of the vehicle undercarriage or temporary stops during a scanning operation in order to particularly examine a suspicious area.

Trailer 300 is capable of making a number of size adjustments to provide flexibility, convenience, and ease of use. These adjustments may be made either manually or using mechanical means, such as motors, electrical drive systems, or hydraulic drive systems, for example. For example, the width of wheel channels 301 may be made adjustable to accommodate vehicles of varying chassis widths and/or different wheel types, sizes or configurations. Similarly, the separation distance between wheel channels 301 may be made adjustable to accommodate vehicles having different chassis widths. Also, the length of wheel channels 301 may be adjusted to accommodate longer or shorter vehicles.

Retractable wheels 305 allow trailer 300 to be readily transported and deployed. Retractable wheels 305 allow trailer 300 to be lifted for towing or other movement and lowered to the ground for deployment. According to the exemplary embodiment shown in FIG. 3A, retractable wheels 305 raise and lower trailer 300 using rotating angled axels 307 attached between frame 302 and retractable wheels 305. Where rotating angled axels 307 are rotated upwards, trailer 300 lowers until it rests flat on the ground. Where rotating angled axels 307 are rotated downwards, trailer 300 rises so that it can be moved. Rotating angled axels 307 are typically rotated using hydraulics or an electric motor. Alternatively, the trailer can be raised or lowered using air-shocks.

FIG. 3B is a side view of trailer 300. FIG. 3B shows retractable ramps 303 in their extended positions. The extended positioning of retractable ramps 303 allows vehicles to drive onto and off of trailer 300. Retractable ramps 303 are placed in a retracted position within frame 302 while trailer 300 is being moved, and may be positioned in an upright position to control the passage of vehicles on and off of trailer 300. For example, the upright positioning of one set of retractable ramps 303 may be used to prevent vehicles from exiting or passing over trailer 300 before a complete inspection has been conducted. A number of alternative means are available for controlling the passage of vehicles on and off trailer 300, including various barriers, such as barrier arms or gates, tire-rippers or spikes, etc.

The height of a deployed under vehicle inspection system, as measured by the distance between the bottom of frame 302 and the top of wheel channels 301 is preferably in the range of around 0.3 meters and the length of wheel channels 302 is preferably around 8 meters, although these dimensions may vary according to overall design and need.

FIG. 3C is a front view of trailer 300. Here, trailer 300 is shown in a deployed position wherein rotating angled axels 307 are rotated upwards and retractable ramps 303 are extended. Wheel well inspectors 308 are optionally attached to frame 302 to enable the under vehicle inspection system to more thoroughly inspect vehicle wheel wells. In one embodiment, wheel well inspectors 308 generally comprise cameras mounted on robotic arms attached to frame 302. Camera(s) within this arrangement may be adjusted in several ways, for example, by rotating, tilt, pan, zoom, etc. Wheel well inspectors 308 may be designed to traverse along wheel well inspection tracks 309 (shown in FIG. 3D) using an electric, mechanical or manual drive means.

FIG. 3D is a second top view of trailer 300. Referring to FIG. 3D, wheel well inspector tracks 309 may span the entire length of trailer 300, giving wheel well inspectors 308 the ability to completely scan side areas of vehicles from front to back, or a wheel well regardless of its particular location on the vehicle.

Various adjustments to trailer 300 and scanning procedures described with respect to FIGS. 3A through 3D may be controlled either by a human operator through a computer or some other synthetic interface, or by an automatic control procedure. Examples of automatic control procedures include use of range finders or machine vision techniques to determine the dimensions of a vehicle, and determination of vehicle dimensions by comparing images of a vehicle against a database of vehicle template images and adjusting trailer 300 and/or the plurality of cameras accordingly.

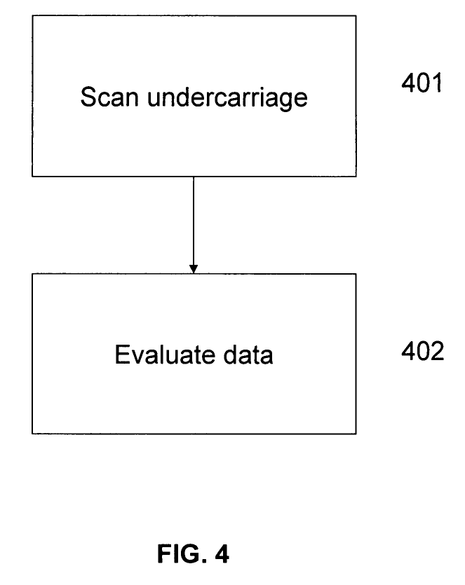

FIG. 4 is a flow chart describing an exemplary method of inspecting the undercarriage of a vehicle in accordance to one embodiment of the invention. Referring to FIG. 4, the method comprises scanning the vehicle undercarriage using a plurality of sensors mounted on a vehicle undercarriage inspection platform (401). The method further comprises evaluating data captured by the sensors using a data analysis element (402). Scanning the vehicle undercarriage typically comprises moving the plurality of sensors relative to the vehicle undercarriage inspection platform. The plurality of sensors typically comprises cameras, chemical sensors, radiation detectors, infrared sensors, or a combination thereof.

Evaluating the data captured by the plurality of sensors typically comprises receiving the data in a digital data processing device such as PC or PDA, displaying the data to a human operator, and allowing the human operator to use subjective or objective criteria to classify the data as suspicious or not suspicious and control the under vehicle inspection system accordingly.

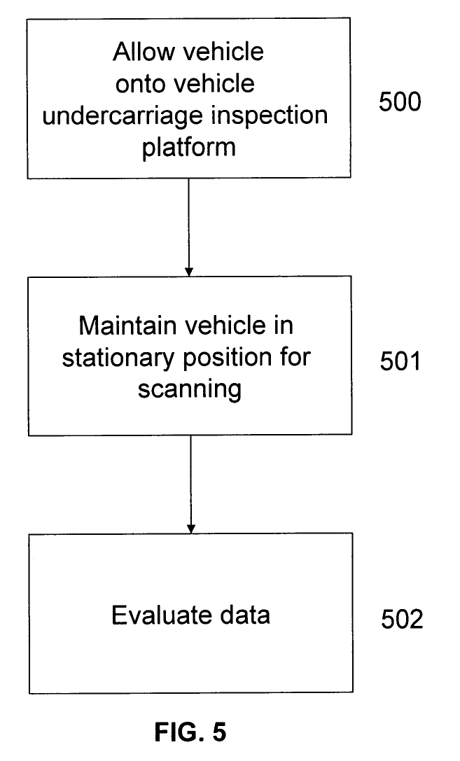

FIG. 5 is a flow chart further describing an exemplary method of inspecting a vehicle undercarriage in accordance with another embodiment of the invention. Referring to FIG. 5, the method comprises allowing the vehicle to drive onto a vehicle undercarriage inspection platform (500), maintaining the vehicle in a stationary position relative to the vehicle undercarriage inspection platform while sensors scan the undercarriage of the vehicle (501), and evaluating data captured by the sensors using a data analysis element (502).

Allowing the vehicle to drive onto the vehicle undercarriage inspection platform may be accomplished using a signaling system such as red light/green light combination, or a movable barrier. However accomplished, the vehicle is positioned so that is undercarriage may be scanned.

Similarly, maintaining the vehicle in a stationary position relative to the vehicle undercarriage inspection platform may be accomplished using barriers to prevent the vehicle from exiting or passing over the vehicle undercarriage inspection platform.

Evaluating the data captured by the plurality of sensors may be accomplished by receiving the data in a computer, displaying the data to a human operator, and allowing the human operator to use subjective or objective criteria to classify the data as suspicious or not suspicious. A determination by the human operator that some of the displayed data is suspicious may result in further examination of the implicated vehicle area, or an alarm actuation warning the general area of the vehicle.

Multiple embodiments of the invention are characterized by the use of a movable under vehicle inspection system, such as trailer. However, this need not always be the case. A fixed, in-ground or on-ground inspection point may be implemented in accordance with the invention. That is, a moveable plurality of sensors may be passed under a stationary vehicle to scanned the entire vehicle undercarriage. Unlike UGVs the plurality of sensors and its scanning path are fixed in relation to the under vehicle inspection system. Accordingly, a more uniform undercarriage scan results.

Those of ordinary skill in the art will recognize that the foregoing embodiments are subject to numerous modifications and adaptations. In this regard, the teaching embodiments are given by way of example and do not exhaust the scope of the invention which is defined by the attached claims.

1. An under vehicle inspection system, comprising:
a vehicle undercarriage inspection platform;
a plurality of sensors associated with the vehicle undercarriage inspection platform and adapted to scan the undercarriage of a stationary vehicle by moving relative to the vehicle undercarriage inspection platform; and,
a data analysis element adapted to receive and evaluate data captured by the plurality of sensors.

2. The under vehicle inspection system of claim 1, wherein the plurality of sensors comprises optical cameras, chemical sensors, thermal sensors, or radiation detectors.

3. The under vehicle inspection system of claim 1, wherein the plurality of sensors comprises a digital line scan camera.

4. The under vehicle inspection system of claim 1, wherein the data captured by the plurality of sensors is received by the data analysis element through a hardwire link connecting the plurality of sensors to the data analysis element.

5. The under vehicle inspection system of claim 1, further comprising a signaling system controlling vehicle positioning relative to the vehicle undercarriage inspection platform before scanning of the undercarriage by the plurality of sensors.

6. The under vehicle inspection system of claim 4, wherein the plurality of sensors comprises a digital line scan camera; and,
wherein the data analysis element comprises a Personal Computer (PC) or Personal Digital Assistant (PDA) adapted to receive data captured by the cameras and display images related to the data to a human operator.

7. The under vehicle inspection system of claim 1, wherein the vehicle undercarriage inspection platform comprises a trailer.

8. The under vehicle inspection system of claim 7, wherein the trailer comprises:
a frame;
wheel channels attached to the frame;
retractable ramps attached to the wheel channels;
retractable wheels attached to the frame;
a camera track attached to the frame; and,
wherein the plurality of sensors comprises a digital line scan camera associated with a camera bar adapted to traverse some portion of the frame via the camera track.

9. The under vehicle inspection system of claim 8, wherein the wheel channels are width adjustable.

10. The under vehicle inspection system of claim 8, wherein the retractable wheels are attached to the frame by rotating angled axels.

11. The under vehicle inspection system of claim 8, wherein the camera bar scans the undercarriage of the vehicle by moving along the camera track.

12. The under vehicle inspection system of claim 8, wherein the trailer further comprises:
wheel well inspector tracks attached to the frame; and,
wheel well inspectors attached to the wheel well inspector tracks.

13. The under vehicle inspection system of claim 12, wherein the wheel well inspectors comprise cameras mounted on robotic arms.

14. A method of inspecting the undercarriage of a stationary vehicle, the method comprising:
scanning the undercarriage of the stationary vehicle positioned on a vehicle undercarriage inspection platform by moving a plurality of sensors relative to the vehicle undercarriage inspection platform; and,
evaluating data captured by the plurality of sensors using a data analysis element.

15. The method of claim 14, wherein the plurality of sensors comprises optical cameras, chemical sensors, thermal detectors, or radiation detectors.

16. The method of claim 15, wherein evaluating the data captured by the plurality of sensors comprises:
receiving the data in a computer, and displaying the data to a human operator.

17. A method of inspecting the undercarriage of a vehicle, the method comprising:
positioning a vehicle in relation to a vehicle undercarriage inspection platform;
maintaining the vehicle in a stationary position relative to the vehicle undercarriage inspection platform while moving a plurality of sensors relative to the undercarriage of the vehicle to scan the vehicle undercarriage with the plurality of sensors; and,
evaluating data captured by the plurality of sensors using a data analysis element.

18. The method of claim 17, wherein the plurality of sensors comprises optical cameras, chemical sensors, thermal sensors, or radiation detectors.

19. The method of claim 17, wherein positioning the vehicle on the vehicle undercarriage inspection platform comprises:
visually indicating to a vehicle operator using a green light and a red light.

20. The method of claim 17, wherein maintaining the vehicle in a stationary position relative to the vehicle undercarriage inspection platform comprises:
moving a barrier adapted to prevent passage or exit of the vehicle from the vehicle undercarriage inspection platform.

21. The method of claim 17, wherein evaluating the data captured by the plurality of sensors comprises:
receiving and evaluating the data in a digital logic system.

22. The under vehicle inspection system of claim 1, wherein the data captured by the plurality of sensors is received by the data analysis element through a wireless link connecting the plurality of sensors to the data analysis element.

23. The under vehicle inspection system of claim 1, further comprising a signaling system controlling vehicle passage relative to the vehicle undercarriage inspection platform.

24. The under vehicle inspection system of claim 1, wherein the plurality of sensors comprises an digital line scan camera having zoom capability.

25. The method of claim 14, wherein the vehicle undercarriage inspection platform comprises a trailer, and wherein the method further comprises:
towing the trailer to a location; and,
deploying the trailer at the location before scanning the undercarriage of the vehicle positioned on the trailer by moving the plurality of sensors relative to the trailer.

26. The method of claim 14, wherein the plurality of sensors comprises a digital line scan camera having zoom capability, and wherein scanning the undercarriage of the vehicle further comprises:
stopping the movement of the plurality of sensors relative to the vehicle undercarriage inspection platform; and,
zooming the digital line scan camera onto a selected portion of the vehicle undercarriage.

27. The method of claim 17, wherein the vehicle undercarriage inspection platform comprises a trailer, and wherein the method further comprises:
towing the trailer to a location; and,
deploying the trailer at the location before positioning the vehicle on the trailer.

28. The method of claim 17, wherein the plurality of sensors comprises a digital line scan camera having zoom capability, and wherein the method further comprises:
stopping the movement of the plurality of sensors relative to the vehicle undercarriage inspection platform during the scan of the vehicle undercarriage; and,
zooming the digital line scan camera onto a selected portion of the vehicle undercarriage.

29. The under vehicle inspection system of claim 1, wherein the plurality of sensors comprises in combination at least two different sensors selected from a group of sensors consisting of: a video camera, a digital line scan camera, a chemical sensor, a thermal sensor, and a radiation detector.

30. The under vehicle inspection system of claim 14, wherein the plurality of sensors comprises in combination at least two different sensors selected from a group of sensors consisting of: a video camera, a digital line scan camera, a chemical sensor, a thermal sensor, and a radiation detector.

31. The under vehicle inspection system of claim 1, wherein the vehicle inspection system comprises an in-ground structure adapted to have a stationary vehicle positioned there over.

32. The under vehicle inspection system of claim 1, wherein the vehicle inspection system comprises an on-ground structure adapted to have a stationary vehicle positioned there over.

33. The under vehicle inspection system of claim 32, wherein the on-ground structure is transportable.

34. The method of claim 14, wherein the vehicle inspection system comprises an in-ground structure, and the method further comprises:
positioning the vehicle over the vehicle inspection system, and thereafter holding the vehicle stationary before scanning the undercarriage.

35. The method of claim 14, wherein the vehicle inspection system comprises an on-ground structure, and the method further comprises:
positioning the vehicle over the vehicle inspection system, and thereafter holding the vehicle stationary before scanning the undercarriage.

36. The method of claim 17, wherein the vehicle inspection system comprises an in-ground structure.

37. The method of claim 17, wherein the vehicle inspection system comprises an on-ground structure.

38. The method of claim 37, where in the on-ground structure is transportable.

39. The method of claim 17, wherein the vehicle inspection system comprises a trailer adapted to be towed.
